(19) United States
(12) Patent Application Publication
(10) Pub. No.: US 2008/0158568 A1
(43) Pub. Date: Jul. 3, 2008

(54) INTERFEROMETER AND METHOD FOR FABRICATING SAME

(75) Inventors: Glenn Scott Claydon, Wynantskill, NY (US); Ayan Banerjee, Karnataka (IN); Shivappa Ningappa Goravar, Karnataka (IN); Renato Guida, Wynantskill, NY (US); David Cecil Hays, Niskayuna, NY (US); Dirk Lange, Bavaria (DE); Boon Kwee Lee, Clifton Park, NY (US); Sandip Maity, Karnataka (IN); Long Que, Rexford (NY); Anis Zribi, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/044,020

(22) Filed: Mar. 7, 2008

Related U.S. Application Data
(63) Continuation-in-part of application No. 11/400,948, filed on Apr. 10, 2006.

(51) Int. Cl. G01B 9/02

(52) U.S. Cl. 356/454

(57) ABSTRACT

An interferometer includes a resonant cavity having a movable mirror and at least one fiber optic component acting as a fixed mirror. A surface of the fiber optic component is coated with a reflective film. An actuator is coupled to the movable mirror, such that when a scattered optical beam is coupled to the cavity, interference occurs between the surface of the fiber optic component coated with reflective film and a surface of the movable mirror facing the surface of the fiber optic component coated with reflective film. The reflective film on the surface of the fiber optic component causes closely spaced spectral lines within the scattered optical beam to be suitably resolved.

### CROSS-REFERENCE TO RELATED APPLICATION

This application is a continuation-in-part application of commonly assigned U.S. patent application Ser. No. 11/400,948, filed Apr. 10, 2006, and incorporated in its entirety by reference herein.

### BACKGROUND OF THE INVENTION

The invention relates generally to tunable filters, and more particularly, to the improved use and fabrication of interferometers.

Tunable optical filters have a wide range of applications. They can also be utilized in Raman spectrometers, namely for non-dispersive Raman spectroscopy. Spectroscopy generally refers to the process of measuring energy or intensity as a function of wavelength in a beam of light or radiation. More specifically, spectroscopy uses the absorption, emission, or scattering of electromagnetic radiation by atoms, molecules, or ions to qualitatively and quantitatively study physical properties and processes of matter. Raman spectroscopy relies on the inelastic scattering of intense, monochromatic light, typically from a laser source operating in the visible, near infrared, or ultraviolet range. Photons of the monochromatic source excite molecules in a sample upon inelastic interaction, resulting in the energy of the laser photons being shifted up or down. The shift in energy yields information about the molecular vibration modes in the system/sample.

For high performance spectroscopy, the filters need to cover a wide spectral range, and need to filter with a high resolution, so that sharp peaks in the spectrum can be resolved.

However, Raman scattering is a comparatively weak effect in comparison to Rayleigh (elastic) scattering in which energy is not exchanged. Depending on the particular molecular composition of a sample, only about one scattered photon in 10⁶ to about 10⁸ tends to be Raman shifted. Because Raman scattering is such a comparatively weak phenomenon, an instrument used to analyze the Raman signal should be able to substantially reject Rayleigh scattering, have a high signal to noise ratio, and have high immunity to ambient light. Otherwise, a Raman shift may not be measurable.

A challenge in implementing Raman spectroscopy is separating the weak inelastically scattered light from the intense Rayleigh-scattered laser light. In the past, the resolution and spectral range requirements were met with high performance gratings, at times combined with fabry-perot etalons coupled to them. Conventional Raman spectrometers typically use reflective or absorptive filters, as well as holographic diffraction gratings and multiple dispersion stages, to achieve a high degree of laser rejection. A photon-counting photomultiplier tube (PMT) or a charge coupled device (CCD) camera may be used to detect the Raman scattered light.

Interferometry is used in spectroscopy for controlling and measuring the wavelength of light. Interferometry is the science and technique of superposing (interfering) two or more waves, which creates an output wave different from the input waves; this in turn can be used to explore the differences between the input waves. A Fabry-Perot interferometer or etalon is typically made of a transparent plate with two reflecting surfaces, or two parallel highly reflecting mirrors. Its transmission spectrum as a function of wavelength exhibits peaks of large transmission corresponding to resonances of the etalon. Fabry-Perot interferometers are widely used in spectroscopy, as recent advances in fabrication technique allow the creation of very precise tunable Fabry-Perot interferometers.

Improvements have been made in spectrometry including the use of Fabry-Perot interferometers fabricated using nano-technology. This makes for a compact and portable spectrometer. However, there is still room for improvement in terms of performance and design.

### SUMMARY

According to an exemplary embodiment, the above discussed and other drawbacks and deficiencies of conventional interferometers may be overcome or alleviated by an interferometer for passing selected wavelengths of a scattered optical beam and by a method for fabricating such an interferometer.

According to exemplary embodiments, an interferometer is provided that includes a resonant cavity having a movable mirror and at least one fiber optic component acting as a fixed mirror. A surface of the fiber optic component is coated with a reflective film. An actuator is coupled to the movable mirror, such that when a scattered optical beam is coupled to the cavity, interference occurs between the surface of the fiber optic component coated with reflective film and a surface of the movable mirror facing the surface of the fiber optic component coated with the reflective film. The reflective film on the surface of the fiber optic component causes closely spaced spectral lines within the scattered optical beam to be suitably resolved.

In one aspect, another fiber optic component is disposed on a side of the movable mirror opposite the fiber optic component acting as a fixed mirror. A surface of the other fiber optic component facing the movable mirror is coated with anti-reflective film to reduce coupling losses.

In another aspect, a surface of the movable mirror facing the fiber optic component acting as a fixed mirror is coated with a reflective film for resolving closely spaced spectral lines within the scattered optical beam, and a surface of the moveable mirror facing the other fiber optic component is coated with an anti-reflective film for reducing coupling losses.

In yet another aspect, the scattered optical beam shines directly onto the movable mirror.

In still another aspect, an optical component is disposed on a side of the movable mirror opposite the fiber optic component acting as a fixed mirror.

In another aspect, a movable mirror holder holds the movable mirror.

In still other aspects, multiple resonant cavities may be formed using various configurations of movable mirrors and fiber optic components acting as fixed mirrors.

In another embodiment, a method is provided for fabricating an interferometer. The method includes coating a surface of a fiber optic component with a reflective film, creating a resonant cavity including a movable mirror and the fiber optic component, and coupling an actuator to the movable mirror, such that when the scattered optical beam is coupled to the cavity, the fiber optic component acts as a fixed mirror. Interference occurs between the surface of the fiber optic component coated with reflective film and a surface of the movable mirror facing the surface of the fiber optic component coated with reflective film. The reflective film on the surface of the fiber optic component causes closely spaced spectral lines within the scattered optical beam to be suitably resolved.

These and other advantages and features will be more readily understood from the following detailed description of preferred embodiments of the invention that is provided in connection with the accompanying drawings.

### BRIEF DESCRIPTION OF THE DRAWINGS

FIG. 1 illustrates a spectrometer in which interferometry may be implemented according to an exemplary embodiment.

FIG. 2 is a perspective view illustrating a comb drive micro actuator for a Fabry-Perot interferometer according to an exemplary embodiment.

FIG. 3 illustrates a simplified version of a Fabry-Perot nano-interferometer.

FIGS. 4-7 illustrate Fabry-Perot interferometers in which a fixed mirror has been removed according to exemplary embodiments.

FIG. 8 illustrates a method for fabricating an interferometer according to exemplary embodiments.

FIGS. 9 and 10 illustrate two-cavity Fabry-Perot interferometers according to exemplary embodiments.

### DETAILED DESCRIPTION OF EXEMPLARY EMBODIMENTS

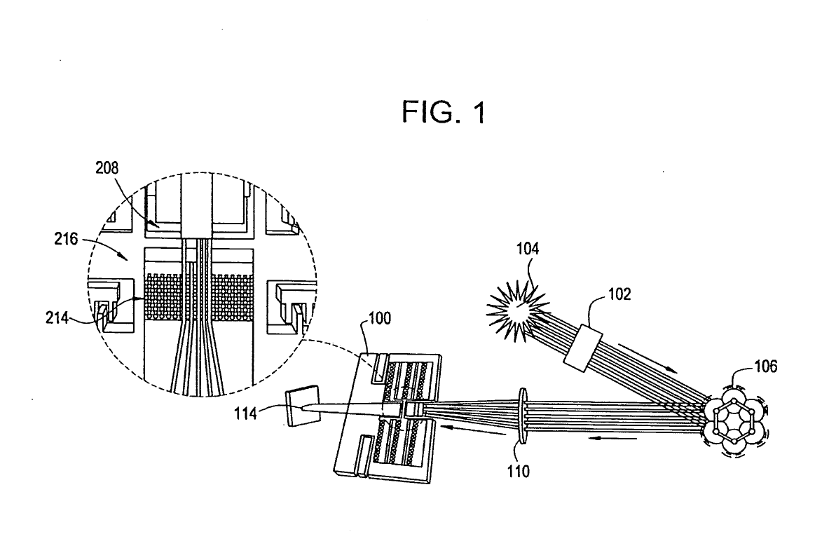

As noted above, Fabry Perot filtering is used in spectrometry. An exemplary spectrometer device in which Fabry Perot filtering may be implemented is shown in FIG. 1. FIG. 1 is a schematic diagram of optical components of a spectrometer device on an integrated chip 100. More specifically, the chip 100 includes a monochromatic optical source 104, such as a laser diode, for example. In addition, irradiation optics (not shown) may be provided for focusing and/or collimating the output of the optical source 104 to be directed at the sample 106 to be tested. The detected optical beam scattered by the sample 106 may be directed back to additional optics on the chip 100 for guiding, filtering, collimation and detection. The filtered signal is detected by a photon detector 114, as further described herein. It will be noted that the particular sequential order in which the received optical signal is passed though various components is not necessarily limited in this manner.

Active control of the optical power density of the device may be achieved through an actuator 102 (e.g., a shutter, an attenuator, a micro lens with tunable focal length) configured to selectively control the amount of optical power directed upon a particular sample 106. This may be desired in instances, for example, where the sample material is temperature sensitive for a variety of reasons. For active control, a temperature-sensing device may also be integrated into the spectrometer system.

Collection optics 110 (having a high numerical aperture) receive the scattered beam from the sample 106, and may be embodied by three-dimensional photonic crystals formed on the chip substrate.

The insert portion of FIG. 1 illustrates the collimation and filtering functions in further detail. The collected beam is routed to a photonic crystal collimator 214 with a taper configured therein. Then, collimated light is passed through a photonic crystal Rayleigh filter 216 to remove the dominating Rayleigh scattered component of the scattered beam at the optical source wavelength. Because of the nano dispersive nature of the MEMS spectrograph/spectrophotometer device (Fabry-Perot filter), the component Raman wavelengths of the Rayleigh-filtered light are not spatially detected by an array of photodetectors, but are instead detected through a tunable Fabry-Perot filter 208.

As is well known, a tunable Fabry-Perot filter includes a resonant cavity and an actuator. The resonant cavity is defined by a pair of micro mirrors, which both can be flat, curved, or one flat and one curved. One of the two mirrors is static while the second mirror is movable and is attached to the actuator. When broadband light is coupled to the cavity, multiple internal reflections and refractions occur and interference between transmitted beams takes place. At specific distances between the two mirrors interference is constructive and an interference pattern is produced on the other end of the Fabry-Perot. The central peak (main mode of the cavity at a specific distance between the mirrors) is a high intensity peak and the transmitted light is monochromatic.

The wavelength of the transmitted light is a function of the distance between the cavity mirrors, thus the filter is a narrow band filter. As the distance between the two mirrors is scanned continuously, multiple interferences take place leading to a continuous scan of the optical spectrum within a specific range of wavelengths. As described in the afore-mentioned copending U.S. patent application Ser. No. 11/400,948, by separating the actuation of the filter from the optics (i.e., the mirrors are not used as electrodes or deflectable membranes). This has the advantage of providing higher spectrograph performance, since the filter may be tuned over longer distances with lower power consumption and without introducing any deformation to the mirrors, which would adversely affect the optical quality of the filter, thus improving the bandwidth.

In addition, the crystallographic planes of a chip substrate (e.g., silicon) may be used to provide high smoothness, high flatness and high parallelism between the cavity mirrors, and therefore high finesse and ultimately high spectral resolution. The actuator itself may be thermal, electrostatic or magnetic in nature. In an exemplary embodiment, MEMS comb drives are used for actuation along with plane mirror cavities (i.e., both mirrors are planar).

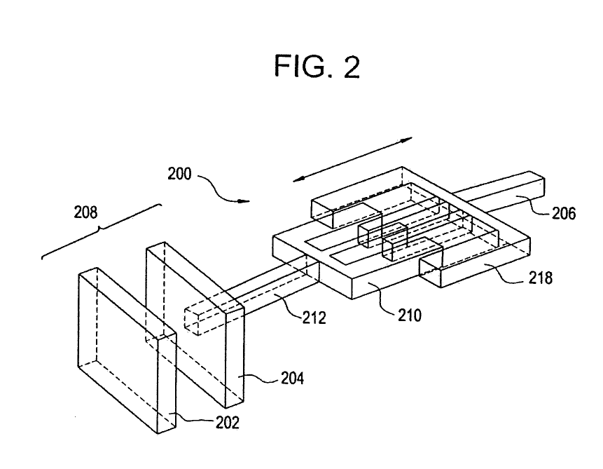

FIG. 2 is a perspective view illustrating an exemplary comb drive micro actuator 200 for a tunable Fabry-Perot filter (interferometer) 208, having a stationary mirror 202 and a movable mirror 204. The actuator 200 includes a stationary portion 206 having individual comb teeth 218 intermeshed with complementary teeth 210 of a movable portion 212 coupled to the movable mirror 204. Controlled electrostatic attraction between the teeth 218 and 210 used in the spectrometer device causes the movable portion 212 to translate in the direction of the arrow, thus changing the distance between the mirrors 202, 204 and the cavity length as a result.

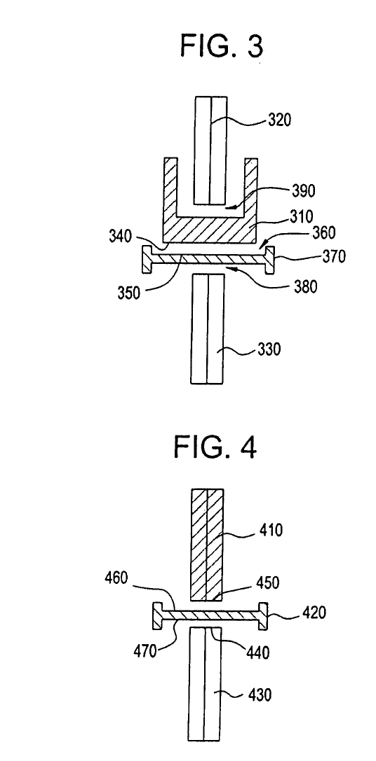

FIG. 3 illustrates a simplified version of a Fabry-Perot nano-interferometer, such as that shown in FIG. 2 and described in the afore-mentioned U.S. patent application Ser. No. 11/400,948. In FIG. 3, the fixed mirror 310, the movable mirror 370 and the Input and Output Fiber Optics 320 and 330 are shown. The motion mechanism formed of teeth is omitted for simplicity of illustration and explanation.

The Fabry-Perot interferometer surfaces 340 and 350 need to have high reflectivity in order to achieve a usable finesse. Finesse is the measure of the interferometer's ability to resolve closely spaced spectral lines. Finesse may be defined as:

F=π×R^{(1/2)}/(1−R)

where R is the reflectivity of the surfaces 340 and 350. This cannot be easily accomplished with a small gap, such as the gap 360, which is about 10 micrometers, and the high aspect ratio (>30) of the two surfaces 340 and 350. These factors limit the accessibility to the surfaces. The mirror's gap 360 is fixed for a specific device. Therefore, if different gaps are needed many different design versions need to be fabricated. Moreover, the fixed mirror 310 introduces transmission losses that are related to the material it is made of and proportional to its thickness. Both of these factors may reduce the overall sensitivity of the device. Also, there are three gaps 360, 380, and 390 in the light path and six surfaces associated with them, which may further reduce overall performance of the device.

According to exemplary embodiments, the performance of the Fabry-Perot nano interferometer may be improved by modifying its mechanical structure, namely the fixed mirror and the movable mirror, and adding or removing certain components. Results of this modification include superior performance, easier fabrication, simpler design, and higher versatility. Although the description below is directed towards Fabry-Perot interferometers, it should be appreciated that the concepts described herein may be applicable to other types of tunable filters/interferometers.

FIG. 4 shows a Fabry-Perot interferometer in which the fixed mirror has been removed according to an exemplary embodiment. In this device, the fiber optic component 410 has substantially the same function as the fixed mirror 310 shown in FIG. 3. In the device shown in FIG. 4, the interference that occurs between the surface 450 of the fiber optic component 410 and the surface 460 of the movable mirror 420 is much the same as that which occurs between surfaces 340 and 350 in the device shown in FIG. 3. However, the surface 450 may be coated easily with a reflective film to ensure the desired reflectivity needed to achieve the best performances, i.e., to achieve the desired finesse F.

The surface 440 of the other fiber optic component 430 may be coated with an anti-reflective film to reduce coupling losses and avoid the formation of a second Fabry-Perot interferometer between the surface 440 of the fiber optic component 430 and the surface 470 of the movable mirror 420.

In the device shown in FIG. 4, the fiber optic components 410 and 430 may be placed in position after the fabrication of the nano-structure which includes the movable mirror 420 and the moving mechanism (not shown in FIG. 4 for simplicity of illustration). Therefore, the two surfaces 460 and 470 of the movable mirror 420 are fully exposed, making it possible to deposit on them reflective and anti-reflective coatings as desired.

Another major advantage is in the positioning of the fiber optic component 410, which acts as a fixed mirror and here can be placed at any desired distance from the surface 460 of the movable mirror 420. This provides high flexibility in device performance.

FIG. 5 illustrates a Fabry-Perot interferometer in which a fiber optic component has been removed according to another embodiment. As shown in FIG. 5, only one fiber optic component 510 is included. Light 530 to be examined is directly shined onto the movable mirror 520. In case of Raman spectroscopy or other similar applications, this interferometer may be situated on the tip of the examining probe, therefore further reducing coupling losses.

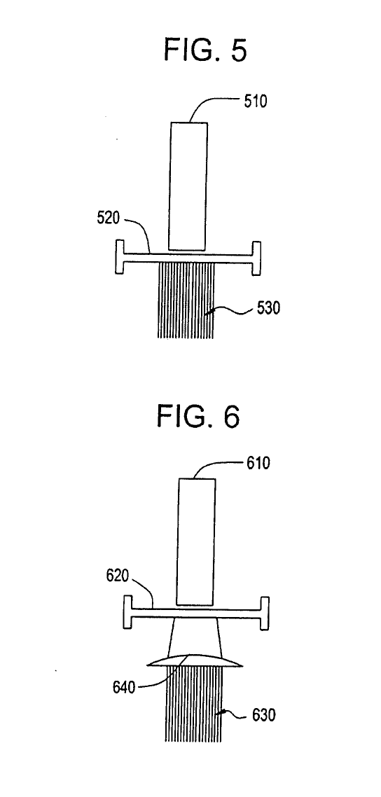

FIG. 6 illustrates a Fabry-Perot interferometer in which an optical component is added according to another exemplary embodiment. As shown in FIG. 6, this interferometer includes, in addition to a fiber optic component 610 and a movable mirror 620, an optical component 640 situated on a side of the movable mirror 620 opposite the fiber optic component 610. The optical component 640 may be a lens, such as a spherical lens, a ball lens, or a grin lens, that makes it easier to collect light 630 and optimizes requirements for the Fabry-Perot input, such as divergence, spot size, etc.

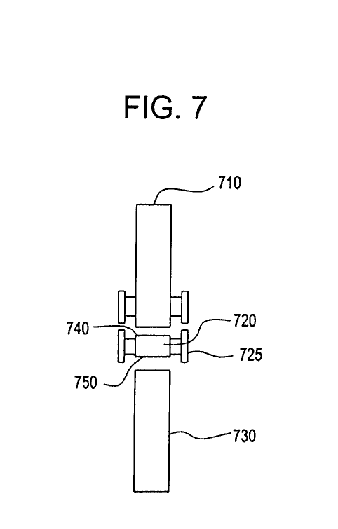

FIG. 7 illustrates a Fabry-Perot interferometer including a mirror holder according to another exemplary embodiment. In FIG. 7, the movable mirror situated between fiber optic components 710 and 730 is replaced with a more complex structure comprising a movable mirror-holder 725 that holds the movable mirror 720. An advantage of this setup is that finesse F, which depends from the reflectivity of the two mirror surfaces 740 and 750, is easily controlled as the components 720 and 725 are detachable and can be positioned and optimized as needed.

According to another embodiment, the resolution of a tunable optical filter may be improved by using two or more mirrors combined in series. In this way, the optical resolution of the filter can be improved without sacrificing free spectral range.

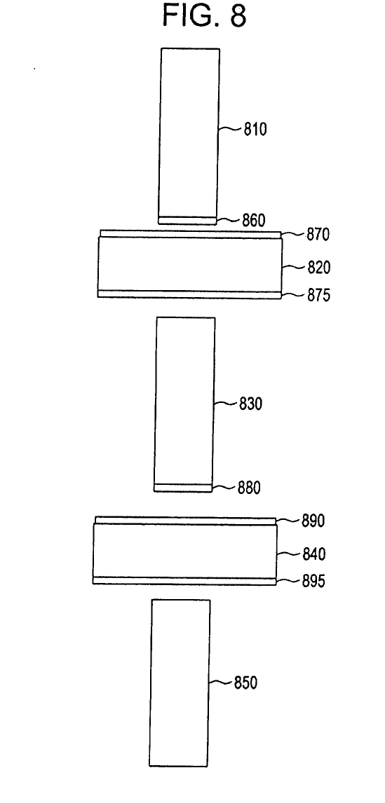

FIG. 8 illustrates a Fabry-Perot interferometer in which another resonant cavity including another movable mirror has been added according to another embodiment. In this device, the fiber optic component 810 acts as a fixed mirror, forming a resonant cavity with the movable mirror 820. To ensure the desired reflectivity needed to achieve the best performances, i.e., to achieve the desired finesse F, the surface 860 of the fiber optic component 810 facing the movable mirror 820 may be coated with reflective film. In addition, the surface 870 of the movable mirror 820 may be coated with reflective film.

In the device shown in FIG. 8, another resonant cavity is formed including another fiber optic component 830, acting as a fixed mirror, and another movable mirror 840. The surface 880 of the fiber optic component 830 facing the movable mirror 840 may be coated with reflective film. In addition, the surface 890 of the movable mirror 840 may be coated with reflective film.

The movable mirror 840 may be disposed between the fiber optic component 830 acting as a fixed mirror and another fiber optic component 850. A surface 895 of the movable mirror 895 may be coated with an anti-reflective film as appropriate.

In the device shown in FIG. 8, the fiber optic components 810, 830, and 850 may be placed in position after the fabrication of the nano-structure which includes the movable mirrors 820 and 840 and the moving mechanisms (not shown in FIG. 8 for simplicity of illustration). Therefore, the surfaces 870, 875, 890, and 895 of the movable mirrors 820 and 840 are fully exposed, making it possible to deposit on them reflective and anti-reflective coatings as desired.

Also, the fiber optic components 810 and 830, which act as fixed mirrors, can be placed at any desired distances from the surfaces 870 and 890 of the movable mirrors 820 and 840, respectively. This provides high flexibility in device performance.

Although not illustrated, the surface of the fiber optic component 830 facing the movable mirror 820 may be coated with anti-reflective film as appropriate. Similarly, the surface of the fiber optic component 850 facing the movable mirror 840 may be coated with anti-reflective film.

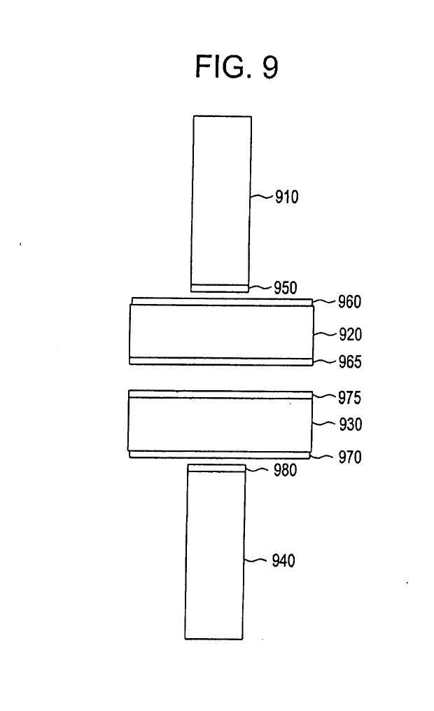

FIG. 9 illustrates a Fabry-Perot interferometer in which another resonant cavity has been added with movable mirrors disposed next to each other according to an exemplary embodiment. In this device, the fiber optic component 910 acts as a fixed mirror, forming a resonant cavity with the movable mirror 920. To ensure the desired reflectivity needed to achieve the best performances, i.e., to achieve the desired finesse F, the surface 950 of the fiber optic component 910 facing the movable mirror 920 may be coated with reflective film. In addition, the surface 960 of the movable mirror 920 may be coated with reflective film.

In the device shown in FIG. 9, another resonant cavity is formed by disposing another movable mirror 930 next to the movable mirror 920 and including another fiber optic component 940, acting as a fixed mirror, on a side of the movable mirror 930 opposite the side facing the movable mirror 920. The surface 980 of the fiber optic component 940 facing the movable mirror 930 may be coated with reflective film. In addition, the surface 970 of the movable mirror 930 may be coated with reflective film. The surfaces 965 and 975 of the movable mirrors 920 and 930, respectively, may be coated with anti-reflective film, as appropriate.

In the device shown in FIG. 9, the fiber optic components 910 and 940 may be placed in position after the fabrication of the nano-structure which includes the movable mirrors 920 and 930 and the moving mechanisms (not shown in FIG. 9 for simplicity of illustration). Therefore, the surfaces 960, 965, 970, and 975 of the movable mirrors 920 and 930 are fully exposed, making it possible to deposit on them reflective and anti-reflective coatings as desired.

Also, the fiber optic components 910 and 940, which act as fixed mirrors, can be placed at any desired distances from the surfaces 960 and 970 of the movable mirrors 920 and 930, respectively. This provides high flexibility in device performance.

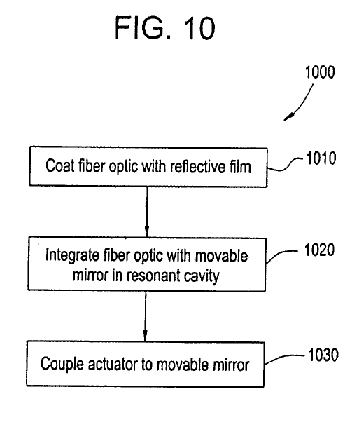

FIG. 10 illustrates an exemplary method 1000 for fabricating an interferometer according to exemplary embodiments. The method beings at step 1010 at which a surface of a fiber optic component is coated with a reflective film. At step 1020, the coated fiber optic component is integrated with a movable mirror in a resonant cavity. The movable mirror may have been microfabricated on a silicon substrate using micromachining techniques or any other methodology and scale. The fiber optic component acts as a fixed mirror. An actuator is coupled to the movable mirror at step 1030, such that when a scattered optical beam is coupled to the cavity, interference occurs between the surface of the fiber optic component coated with reflective film and a surface of the movable mirror facing the surface of the fiber optic component coated with reflective film, and the reflective film on the surface of the fiber optic component causes closely spaced spectral lines within the scattered optical beam to be suitably resolved.

The method shown in FIG. 10 may include optional steps not shown for simplicity of illustration. For example, the method may include adding another fiber optic coated with an anti-reflective film, coating opposite surfaces of the movable mirror with reflective and anti-reflective films, as appropriate, coupling an optical component to the side of the movable mirror opposite the fiber optic coated with the reflective film, incorporating the mirror in a mirror holder, adding one or more mirrors (which may be fabricated on the same substrate), with or without fiber optic components in between, coated with reflective and anti-reflective film, as appropriate. Each of these optional steps has its own advantages in terms of improving collection of light, resolving closely spaced spectral lines, and reducing coupling losses.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An interferometer for passing selected wavelengths of a scattered optical beam, comprising:
a resonant cavity including a movable mirror and at least one fiber optic component acting as a fixed mirror, wherein a surface of the fiber optic component is coated with a reflective film; and
an actuator coupled to the movable mirror, such that when the scattered optical beam is coupled to the cavity, interference occurs between the surface of the fiber optic component coated with reflective film and a surface of the movable mirror facing the surface of the fiber optic component coated with reflective film, and the reflective film on the surface of the fiber optic component causes closely spaced spectral lines within the scattered optical beam to be suitably resolved.

2. The interferometer of claim 1, wherein the resolution of the closely spaced spectral lines within the scattered optical beam is a function of reflectivity between the surface of the fiber optic component coated with the reflective film and the surface of the movable mirror facing the surface of the fiber optic component coated with the reflective film.

3. The interferometer of claim 1, further comprising another fiber optic component disposed on a side of the movable mirror opposite the fiber optic component acting as a fixed mirror, wherein a surface of the other fiber optic component facing the movable mirror is coated with anti-reflective film to reduce coupling losses.

4. The interferometer of claim 3, wherein a surface of the movable mirror facing the fiber optic component acting as a fixed mirror is coated with a reflective film for resolving closely spaced spectral lines within the scattered optical beam, and a surface of the movable mirror facing the other fiber optic component is coated with an anti-reflective film for reducing coupling losses.

5. The interferometer of claim 1, wherein the scattered optical beam shines directly onto the movable mirror.

6. The interferometer of claim 1, further comprising an optical component disposed on a side of the movable mirror opposite the fiber optic component acting as a fixed mirror.

7. The interferometer of claim 1, further comprising a movable mirror holder for holding the movable mirror.

8. The interferometer of claim 1, wherein the interferometer is included in a spectrometer on a chip.

9. The interferometer of claim 1, further comprising at least one other resonant cavity including another movable mirror and at least one other fiber optic component acting as a fixed mirror, wherein a surface of the other fiber optic component acting as a fixed mirror facing the other movable mirror is coated with a reflective film, and the other fiber optic component acting as a fixed mirror is disposed between the movable mirrors.

10. The interferometer of claim 1, further comprising at least one other resonant cavity including another movable mirror and at least one fiber optic component acting as a fixed mirror, wherein the movable mirrors are disposed next to each other, surfaces of the movable mirrors facing each other are coated with anti-reflective film, and a surface of the other fiber optic component acting as a fixed mirror facing the other movable mirror is coated with a reflective film.

11. A method for fabricating an interferometer for passing selected wavelengths of a scattered optical beam, comprising:
coating a surface of a fiber optic component with a reflective film;
creating a resonant cavity including a movable mirror and the fiber optic component, wherein the fiber optic component acts as a fixed mirror; and
coupling an actuator to the movable mirror, such that when the scattered optical beam is coupled to the cavity, interference occurs between the surface of the fiber optic component coated with reflective film and a surface of the movable mirror facing the surface of the fiber optic component coated with reflective film, and the reflective film on the surface of the fiber optic component causes closely spaced spectral lines within the scattered optical beam to be suitably resolved.

12. The method of claim 11, wherein the resolution of the closely spaced spectral lines within the scattered optical beam is a function of reflectivity between the surface of the fiber optic component coated with the reflective film and the surface of the movable mirror facing the surface of the fiber optic component coated with the reflective film.

13. The method of claim 11, further comprising coating a surface of another fiber optic component with an anti-reflective film and disposing the other fiber optic component on a side of the movable mirror opposite the fiber optic component acting as a fixed mirror, wherein the surface of the other fiber optic component coated with the anti-reflective film faces the movable mirror to reduce coupling losses.

14. The method of claim 13, further comprising coating a surface of the movable mirror facing the fiber optic component acting as a fixed mirror with a reflective film for resolving closely spaced spectral lines within the scattered optical beam and coating a surface of the movable mirror facing the other fiber optic component with an anti-reflective film for reducing coupling losses.

15. The method of claim 11, wherein the scattered optical beam shines directly onto the movable mirror.

16. The method of claim 11, further comprising disposing an optical component on a side of the movable mirror opposite the fiber optic component acting as a fixed mirror.

17. The method of claim 11, further comprising including a movable mirror holder holding the movable mirror.

18. The method of claim 11, further comprising including the interferometer in a spectrometer on a chip.

19. The method of claim 11, further comprising:
coating a surface of another fiber optic component with a reflective film;
creating another resonant cavity including another movable mirror and the other fiber optic component, wherein the other fiber optic component acts as a fixed mirror; and
coupling another actuator to the other movable mirror.

20. The method of claim 11, further comprising:
disposing another movable mirror next to the movable mirror;
coating surfaces of the movable mirrors facing each other with anti-reflective film;
coating a surface of another fiber optic component with a reflective film; and
creating another resonant cavity including the other movable mirror and the other fiber optic component, wherein the other fiber optic component acts as a fixed mirror; and
coupling another actuator to the other movable mirror.
